(19) United States
(12) Patent Application Publication
(10) Pub. No.: US 2021/0360922 A1
(43) Pub. Date: Nov. 25, 2021

(54) HERBICIDAL COMBINATIONS

(71) Applicant: UPL LTD, Haldia (IN)

(72) Inventors: Ajit KUMAR, Mumbai (IN); Jaidev Rajnikant SHROFF, Dubai (AE); Vikram Rajnikant SHROFF, Dubai (AE)

(21) Appl. No.: 16/767,398

(22) PCT Filed: Nov. 27, 2018
(86) PCT No.: PCT/IB2018/059343

§ 371 Date: May 27, 2020

(30) Foreign Application Priority Data
Nov. 28, 2017 (IN) 201731042657

(51) Int. Cl. A01N 43/707; A01N 43/54; A01N 37/36

(52) U.S. Cl. CPC A01N 43/707; A01N 2300/00; A01N 37/36; A01N 43/54

(57) ABSTRACT

Disclosed herein is a A herbicidal combination comprising saflufenacil, Napropamide or Napropamide-M and a third herbicide.

### TECHNICAL FIELD

The present invention relates to a herbicidal combination for controlling undesirable plants. The present invention more specifically relates to a synergistic combination of herbicides for controlling weeds.

### BACKGROUND AND PRIOR ART

Weeds are undesirable plants that can severely damage yield in crops. Farmers usually control these plants at the pre-plant stage as well as after sowing. Modern herbicides are used to either control or suppress these undesirable plants so as to allow sown crops a greater share of nutrient.

Current practices include combining herbicides with varied modes of action, which allows broader spectrum of control and resistance management. However, the combinations currently known are not sufficient to control resistant and persistent weeds. Growers, increasingly face complex weed situations that may not be controlled with just one herbicide. There is always a need in the art for improved herbicidal combinations with enhanced weed control efficacy.

PPO inhibitor herbicides are mostly used to injure broadleaf plants and have some activity on grasses. They have a limited translocation in plants and are used to control weeds in field crops, vegetables, tree fruits and vines, small fruits, nurseries, lawns, etc. PPO inhibitors usually burn plant tissues within hours or days of exposure, making them an excellent tool to control unwanted weeds both pre and post emergent.

Saflufenacil is PPO inhibitor herbicide that is used for both pre-plant burndown as well as post emergent control of weeds. Combination of Saflufenacil with other broad spectrum herbicides are known from WO2016113334 (Massa et.al) or US2013244876 (Thorsten et.al). Massa et al teach a combination comprising saflufenacil, glufosinate and a third herbicide selected from metribuzin, S-metolachlor, flumioxazin, clodinafop or clethodim. Thorsten et al teach a combination comprising saflufenacil and ethephon or cyclanilide.

Very long chain fatty acid inhibitors are selective herbicides that prevent root cell elongation. These herbicides act systemically by being absorbed through roots and then translocated. These herbicides are generally applied pre-emergent to control a range of weeds including annual grasses and some broadleaf weeds in several crops such as in vegetables, vines, bushes, sunflower, tobacco, ornamentals etc. Absorbed by roots and shoots, these herbicides cause cell damage and are an excellent tool to control both pre-emergent weeds. Napropamide and/or Napropamide-M are examples of very long chain fatty acid inhibitor herbicides, which is used pre-emergent for control of broadleaf and annual grasses. Napropamide is known to be used in combination such as those known from JP 2016-88913 A (Nakamura, Arata et.al) teach combinations of PPO inhibitors with very long chain fatty acid inhibitors and a plant activator for turf. U.S. Pat. No. 9,307,765 B2 (Shroff et.al.) teach combinations of Napropamid-M with various other herbicides. However, prior art does not teach the use of specific PPO inhibitors and specific very long chain fatty acid inhibitors with additional specific herbicides for the yet better control of weeds in agricultural lands.

A combination of herbicides may not always result in the desired effect. Combination of herbicides may lead to an additive effect or an antagonistic effect. It may also result in phytotoxicity to the crops making it an undesirable combination. Agronomists must therefore, carefully select the herbicides that can be combined to offer a synergistic effect that would control weeds while having no phytotoxic effect on the crop, and reduce the chances of development of herbicide resistant weeds.

Protection of planted crops from undesirable plants which inhibit crop growth is a perpetual struggle for all farmers. Herbicides have been used to control growth of such plants. There are many herbicides and combinations known in the art. There still remains a need for improved herbicidal combinations that can effectively control weeds thereby improving yield and plant health, with reduced phytotoxicity.

Saflufenacil is a PPO inhibitor herbicide. Its chemical name is N′-{2-chloro-4-fluoro-5-[1,2,3,6-tetrahydro-3-methyl-2,6-dioxo-4-(trifluoromethyl)pyrimidin-1-yl]benzoyl}-N-isopropyl-N-methylsulfamide.

Napropamide and its isomer Napropamide-M are very long chain fatty acid inhibitor herbicides. Their chemical names are (RS)—N,N-diethyl-2-(1-naphthyloxy)propionamide and (R)—N,N-diethyl-2-(1-naphthyloxy)propionamide respectively.

Saflufenacil alone is usually effective for control of early season broadleaf weed control. However, its weed control efficacy reduced beyond 30 days after treatment. The use of a combination of herbicides with specific modes of action may leave other weeds completely untouched. There is therefore, a need in the art, for an herbicidal combination which offers a broader and more complete spectrum of weed control, which can give a better control of weeds at lower use rates, and which gives good residual control.

There is therefore a need in the art for combinations that have advantageous properties such as a herbicidal combination that is synergistic, helps in resistance management, reduces dosage of herbicides used thus causing minimal damage to the environment, or a herbicidal combination that has excellent residual effects.

Embodiments of the present invention may therefore ameliorate one or more of the above mentioned problems:

### OBJECTS OF THE INVENTION

Therefore, one object of the present invention is to provide a synergistic herbicidal combination comprising saflufenacil wherein the weed control efficacy of saflufenacil does not reduce with continued usage.

Another object of the present invention is to provide a synergistic herbicidal combination comprising saflufenacil wherein the weed control efficacy of saflufenacil does not reduce for at least 30 days after treatment.

Yet another object of the present invention is to provide a synergistic herbicidal combination comprising saflufenacil wherein the weed control efficacy of saflufenacil does not reduce with continued usage.

Another object of the present invention is to provide a synergistic herbicidal combination which offers a broader and more complete spectrum of weed control.

Another object of the present invention is to provide a synergistic herbicidal combination which provides a better control of weeds at lower use rates, and which gives good residual control.

Another object of the present invention is to provide a synergistic herbicidal combination which is synergistic and thus helps in resistance management.

Some or all these and other objects of the invention can be achieved by way of the invention described hereinafter.

### SUMMARY OF THE INVENTION

A synergistic herbicidal combination comprising saflufenacil, napropamide or napropamide-M and a third herbicide

A method of controlling weeds at a locus, the method comprising applying a combination comprising saflufenacil, napropamide or napropamide-M and a third herbicide to the locus.

A composition comprising of saflufenacil, napropamide or napropamide-M and a third herbicide and at least one agrochemically acceptable excipient.

A method of controlling weeds at a locus, said method comprising applying a composition comprising saflufenacil, napropamide or napropamide-M and a third herbicide and at least one agrochemically acceptable excipient.

### DETAILED DESCRIPTION OF THE INVENTION

Thus, embodiments of the present invention may present synergistic combinations comprising saflufenacil, napropamide or napropamide-M and a third herbicide.

Surprisingly, it has been found by the present inventors that the combination of specific herbicides, belonging to classes PPO inhibitors, very long chain fatty acid inhibitors and a third herbicide results in a synergistic control of undesirable plants, at the locus of the desirable crop plants.

The term herbicide, as used herein, shall mean an active ingredient that kills, controls or otherwise adversely modifies the growth of undesirable plants. As used herein, a herbicidally effective or vegetation controlling amount is an amount of active ingredient that causes a “herbicidal effect,” i.e., an adversely modifying effect and includes deviations from natural development, killing, regulation, desiccation, retardation. The terms “plants” and “vegetation” include, but are not limited to, germinant seeds, emerging seedlings, plants emerging from vegetative propagules, and established vegetation. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

Thus an embodiment of the present invention may be a herbicidal combination comprising saflufenacil, napropamide or napropamide-M and a third herbicide.

The combination may be applied to the locus of the weeds in an herbicidally effective amount. The selection of the appropriate effective amounts depends on the density of weed infestation, weather patterns, crop health and many other factors, which may be made conveniently by a person skilled in the art. The effective amounts of these herbicides in the synergistic combination of the present invention is not particularly limiting.

Thus, in an embodiment, the third herbicide may be selected from but not limited to herbicides belonging to classes such as acetolactate acid synthase (ALS) inhibitors; acetyl CoA carboxylase (ACCase) inhibitors, EPSP synthase inhibitors, synthetic auxins, auxin transport inhibitors, glutamate synthase inhibitors, HPPD inhibitors, lipid synthesis inhibitors, carotenoid biosynthesis inhibitors, very long chain fatty acid inhibitors, photosystem inhibitors, PPO inhibitors, microtubule inhibitors as well as herbicides with unknown modes of action.

In an embodiment, the third herbicide may be an ACCase inhibitor selected from but not limited to aryloxyphenoxypropionate herbicide such clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, and pinoxaden or mixtures thereof.

Thus an embodiment of the present invention may be a herbicidal combination comprising saflufenacil, napropamide or napropamide-M and a third herbicide selected from aryloxyphenoxypropionate herbicide such clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, and pinoxaden or mixtures thereof.

In an embodiment, the third herbicide may be an ALS inhibitor selected from but not restricted to amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfomeclomazoturon, sulfometuron-methyl, sulfosulfuron, trifloxysulfuron-sodium salt, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thiencarbazone, thiencarbazone-methyl thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, ipfencarbazone, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt, pyrithiobac, pyrithiobac-sodium salt, pyriminobac, pyriminobac-methyl, bispyribac, bispyribac sodium salt, pyribenzoxim, pyrimisulfan, pyriftalid, and triafamone.

Thus an embodiment of the present invention may be a herbicidal combination comprising saflufenacil, napropamide or napropamide-M and a third herbicide selected from amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium salt, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thiencarbazone, thiencarbazone-methyl thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, ipfencarbazone, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt, pyrithiobac, pyrithiobac-sodium salt, pyriminobac, pyriminobac-methyl, bispyribac, bispyribac sodium salt, pyribenzoxim, pyrimisulfan, pyriftalid, and triafamone.

In an embodiment, the EPSP synthase inhibitors may be selected from but not limited to glyphosate, glyphosate-isopropylamine salt, glyphosate-trimesium salt, glyphosate-ammonium salt, glyphosate-diammonium salt, glyphosate-sodium salt, glyphosate-potassium salt, and glyphosate-guanidine salt.

Thus an embodiment of the present invention may be a herbicidal combination comprising saflufenacil, napropamide or napropamide-M and a third herbicide selected from glyphosate, glyphosate-isopropylamine salt, glyphosate-trimesium salt, glyphosate-ammonium salt, glyphosate-diammonium salt, glyphosate-sodium salt, glyphosate-potassium salt, and glyphosate-guanidine salt.

In an embodiment, third herbicide may be a synthetic auxin which may be selected from but not limited to dicamba and a salt thereof (diglycolamine salt, dimethylammonium salt, isopropylammonium salt, potassium salt, sodium salt, and choline salt), 2,4-D and a salt or ester thereof (butotyl ester, dimethylammonium salt, diolamine salt, ethylhexyl ester, isooctyl ester, isopropylammonium salt, sodium salt, and triisopropanolamine salt), 2,4-DB and a salt or ester thereof (dimethylammonium salt, isooctyl ester, and choline salt), MCPA and a salt or ester thereof (dimethylammonium salt, 2-ethylhexylester, isooctyl ester, sodium salt, and choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, tololamine salt, and choline salt), mecoprop-P and a salt or ester thereof (dimethylammonium salt, 2-ethylhexyl ester, isobutyl salt, potassium salt, and choline salt), dichlorprop and a salt or ester thereof (butotyl ester, dimethylammonium salt, 2-ethylhexyl ester, isooctyl ester, methyl ester, potassium salt, sodium salt, and choline salt), dichlorprop-P, dichlorprop-P dimethylammonium, triclopyr and a salt or ester thereof (butotyl ester and triethylammonium salt), fluoroxypyr, fluoroxypyr-meptyl, picloram and a salt thereof (potassium salt, triisopanolammonium salt, and choline salt), quinclorac, quinmerac, aminopyralid and a salt thereof (potassium salt, triisopanolammonium salt, and choline salt), clopyralid and a salt thereof (olamine salt, potassium salt, triethylammonium salt, and choline salt), and clomeprop, florpyrauxifen and salts and esters thereof, halauxifen and salts and esters.

Thus an embodiment of the present invention may be a herbicidal combination comprising saflufenacil, napropamide or napropamide-M and a third herbicide selected from dicamba and a salt thereof (diglycolamine salt, dimethylammonium salt, isopropylammonium salt, potassium salt, sodium salt, and choline salt), 2,4-D and a salt or ester thereof (butotyl ester, dimethylammonium salt, diolamine salt, ethylhexyl ester, isooctyl ester, isopropylammonium salt, sodium salt, and triisopropanolamine salt), 2,4-DB and a salt or ester thereof (dimethylammonium salt, isooctyl ester, and choline salt), MCPA and a salt or ester thereof (dimethylammonium salt, 2-ethylhexylester, isooctyl ester, sodium salt, and choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, tololamine salt, and choline salt), mecoprop-P and a salt or ester thereof (dimethylammonium salt, 2-ethylhexyl ester, isobutyl salt, potassium salt, and choline salt), dichlorprop and a salt or ester thereof (butotyl ester, dimethylammonium salt, 2-ethylhexyl ester, isooctyl ester, methyl ester, potassium salt, sodium salt, and choline salt), dichlorprop-P, dichlorprop-P dimethylammonium, triclopyr and a salt or ester thereof (butotyl ester and triethylammonium salt), fluoroxypyr, fluoroxypyr-meptyl, picloram and a salt thereof (potassium salt, triisopanolammonium salt, and choline salt), quinclorac, quinmerac, aminopyralid and a salt thereof (potassium salt, triisopanolammonium salt, and choline salt), clopyralid and a salt thereof (olamine salt, potassium salt, triethylammonium salt, and choline salt), and clomeprop, florpyrauxifen and salts and esters thereof, halauxifen and salts and esters.

In an embodiment, the third herbicide may be an auxin transport inhibitor, which may be selected from but not limited to diflufenzopyr, and naptalam.

Thus an embodiment of the present invention may be a herbicidal combination comprising saflufenacil, napropamide or napropamide-M and a third herbicide selected from diflufenzopyr, and naptalam.

In an embodiment, the third herbicide may be a glutamate synthase inhibitor herbicide, which may be selected from but not limited to glufosinate, glufosinate-ammonium salt, glufosinate-P, glufosinate-P-sodium salt, and bialaphos.

Thus an embodiment of the present invention may be a herbicidal combination comprising saflufenacil, napropamide or napropamide-M and a third herbicide selected from glufosinate, glufosinate-ammonium salt, glufosinate-P, glufosinate-P-sodium salt, and bialaphos.

In an embodiment, the third herbicide may be a HPPD inhibitors herbicide, which may be selected from but not limited to benzobicyclon, bicyclopyrone, fenquinotrione, mesotrione, sulcotrione, tefuryltrione, tembotrione, isoxachlorotole, isoxaflutole, benzofenap, pyrasulfotole, pyrazolynate, pyrazoxyfen, tolpyralate, and topramezone.

Thus an embodiment of the present invention may be a herbicidal combination comprising saflufenacil, napropamide or napropamide-M and a third herbicide selected from benzobicyclon, bicyclopyrone, fenquinotrione, mesotrione, sulcotrione, tefuryltrione, tembotrione, isoxachlorotole, isoxaflutole, benzofenap, pyrasulfotole, pyrazolynate, pyrazoxyfen, tolpyralate, and topramezone.

In an embodiment, the third herbicide may be a lipid synthesis inhibitor herbicide, which may be selected from but not limited to butylate, cycloate, eptc, eptam, thiobencarb, triallate.

Thus an embodiment of the present invention may be a herbicidal combination comprising saflufenacil, napropamide or napropamide-M and a third herbicide selected from butylate, cycloate, eptc, eptam, thiobencarb, triallate.

In an embodiment, the third herbicide may be a carotenoid biosynthesis inhibitor herbicide, which may be selected from but not limited to diflufenican, picolinafen, beflubutamid, norflurazon, fluridone, fluorochloridone, and flurtamone.

Thus an embodiment of the present invention may be a herbicidal combination comprising saflufenacil, napropamide or napropamide-M and a third herbicide selected from diflufenican, picolinafen, beflubutamid, norflurazon, fluridone, fluorochloridone, and flurtamone.

In an embodiment, the third herbicide may be selected from long chain fatty acid inhibitor herbicide which may be selected from but not limited to propachlor, metazachlor, alachlor, acetochlor, metolachlor, S-metolachlor, butachlor, pretilachlor, thenylchlor, indanofan, cafenstrole, fentrazamide, dimethenamid, dimethenamid-P, mefenacet, pyroxasulfone, fenoxasulfone, naproanilide, pyroxasulfone, anilofos, and flufenacet.

Thus an embodiment of the present invention may be a herbicidal combination comprising saflufenacil, napropamide or napropamide-M and a third herbicide selected from propachlor, metazachlor, alachlor, acetochlor, metolachlor, S-metolachlor, butachlor, pretilachlor, thenylchlor, indanofan, cafenstrole, fentrazamide, dimethenamid, dimethenamid-P, mefenacet, pyroxasulfone, fenoxasulfone, naproanilide, pyroxasulfone, anilofos, and flufenacet.

In an embodiment, the third herbicide may be selected from photosystem inhibitor herbicides which may be selected from but not limited to loxynil, ioxynil octanoate, bentazone, pyridate, bromoxynil, bromoxynil octanoate, chlorotoluron, dimefuron, diuron, linuron, fluometuron, isoproturon, isouron, tebuthiuron, benzthiazuron, methabenzthiazuron, propanil, metobromuron, metoxuron, monolinuron, siduron, simazine, atrazine, propazine, cyanazine, ametryne, simetryn, dimethametryn, prometryn, terbumeton, terbuthylazine, terbutryn, trietazine, hexazinone, metamitron, metribuzin, amicarbazone, bromacil, lenacil, terbacil, chloridazon, desmedipham, and phenmedipham.

Thus an embodiment of the present invention may be a herbicidal combination comprising saflufenacil, napropamide or napropamide-M and a third herbicide selected from loxynil, ioxynil octanoate, bentazone, pyridate, bromoxynil, bromoxynil octanoate, chlorotoluron, dimefuron, diuron, linuron, fluometuron, isoproturon, isouron, tebuthiuron, benzthiazuron, methabenzthiazuron, propanil, metobromuron, metoxuron, monolinuron, siduron, simazine, atrazine, propazine, cyanazine, ametryne, simetryn, dimethametryn, prometryn, terbumeton, terbuthylazine, terbutryn, trietazine, hexazinone, metamitron, metribuzin, amicarbazone, bromacil, lenacil, terbacil, chloridazon, desmedipham, and phenmedipham.

In an embodiment, the third herbicide may be selected from PPO inhibitor herbicide azafenidin, oxadiazone, oxadiargyl, carfentrazone, carfentrazone-ethyl, cinidon, cinidon-ethyl, sulfentrazone, pyraclonil, pyraflufen, pyraflufen-ethyl, butafenacil, fluazolate, fluthiacet, fluthiacet-methyl, flufenpyr, flufenpyr-ethyl, flumiclorac, flumiclorac-pentyl, pentoxazone, oxyfluorfen, acifluorfen, aclonifen, chlomethoxynil, chloronitrofen, nitrofen, bifenox, fluoroglycofene, fluoroglycofene-ethyl, fomesafen, fomesafen-sodium salt, lactofen, trifludimoxazin, and tiafenacil

Thus an embodiment of the present invention may be a herbicidal combination comprising saflufenacil, napropamide or napropamide-M and a third herbicide selected from azafenidin, oxadiazone, oxadiargyl, carfentrazone, carfentrazone-ethyl, cinidon, cinidon-ethyl, sulfentrazone, pyraclonil, pyraflufen, pyraflufen-ethyl, butafenacil, fluazolate, fluthiacet, fluthiacet-methyl, flufenpyr, flufenpyr-ethyl, flumiclorac, flumiclorac-pentyl, pentoxazone, oxyfluorfen, acifluorfen, aclonifen, chlomethoxynil, chloronitrofen, nitrofen, bifenox, fluoroglycofene, fluoroglycofene-ethyl, fomesafen, fomesafen-sodium salt, lactofen, trifludimoxazin, and tiafenacil

In an embodiment, the third herbicide may be a microtubule inhibitor herbicide which may be selected from but not limited to trifluralin, pendimethalin, ethafluralin, benfluralin, prodiamine, indaziflam, triaziflam, butamifos, dithiopyr, and thiazopyr.

Thus an embodiment of the present invention may be a herbicidal combination comprising saflufenacil, napropamide or napropamide-M and a third herbicide selected from trifluralin, pendimethalin, ethafluralin, benfluralin, prodiamine, indaziflam, triaziflam, butamifos, dithiopyr, and thiazopyr.

In an embodiment, the third herbicide may be a herbicide with unknown modes of action, which may be selected from but not limited to molinate, esprocarb, pyributicarb, prosulfocarb, orbencarb, dimepiperate, aminocyclopyrachlor, am inocyclopyrachlor-methyl, aminocyclopyrachlor-potassium, difenoxuron, methyl dymron, bromobutide, dymron, cumyluron, diflufenzopyr, etobenzanid, tridiphane, amitrole, fenchlorazole, maleic hydrazide, oxaziclomefone, benfuresate, ACN, dalapon, chlorthiamid, flupoxam, bensulide, paraquat, paraquat-dichloride, lancotrione and its salts and esters, diquat, and diquat-dibromide, cyclopyrimorate, clacyfos

Thus an embodiment of the present invention may be a herbicidal combination comprising saflufenacil, napropamide or napropamide-M and a third herbicide selected from molinate, esprocarb, pyributicarb, prosulfocarb, orbencarb, dimepiperate, aminocyclopyrachlor, am inocyclopyrachlor-methyl, aminocyclopyrachlor-potassium, difenoxuron, methyl dymron, bromobutide, dymron, cumyluron, diflufenzopyr, etobenzanid, tridiphane, amitrole, fenchlorazole, maleic hydrazide, oxaziclomefone, benfuresate, ACN, dalapon, chlorthiamid, flupoxam, bensulide, paraquat, paraquat-dichloride, lancotrione and its salts and esters, diquat, and diquat-dibromide, cyclopyrimorate, clacyfos

Another embodiment of the present invention may be a herbicidal combination comprising saflufenacil, napropamide or napropamide-M and clodinafop or clodinafop-propargyl.

Another embodiment of the present invention may be a herbicidal combination comprising saflufenacil, napropamide or napropamide-M and haloxyfop or haloxyfop-methyl.

Another embodiment of the present invention may be a herbicidal combination comprising saflufenacil, napropamide or napropamide-M and bensulfuron or bensulfuron-methyl.

Another embodiment of the present invention may be a herbicidal combination comprising saflufenacil, napropamide or napropamide-M and pyrazosulfuron or pyrazosulfuron-ethyl.

Another embodiment of the present invention may be a herbicidal combination comprising saflufenacil, napropamide or napropamide-M and sulfosulfuron.

Another embodiment of the present invention may be a herbicidal combination comprising saflufenacil, napropamide or napropamide-M and trifloxysulfuron-sodium salt or trifloxysulfuron.

Another embodiment of the present invention may be a herbicidal combination comprising saflufenacil, napropamide or napropamide-M and metsulfuron or metsulfuron-methyl.

Another embodiment of the present invention may be a herbicidal combination comprising saflufenacil, napropamide or napropamide-M and penoxsulam.

Another embodiment of the present invention may be a herbicidal combination comprising saflufenacil, napropamide or napropamide-M and imazamox or imazamox-ammonium salt.

Another embodiment of the present invention may be a herbicidal combination comprising saflufenacil, napropamide or napropamide-M and imazapic or imazapic-ammonium salt.

Another embodiment of the present invention may be a herbicidal combination comprising saflufenacil, napropamide or napropamide-M and imazethapyr or imazethapyr-ammonium salt.

Another embodiment of the present invention may be a herbicidal combination comprising saflufenacil, napropamide or napropamide-M and bispyribac or bispyribac sodium salt.

Another embodiment of the present invention may be a herbicidal combination comprising saflufenacil, napropamide or napropamide-M and a herbicide selected from glyphosate, glyphosate-isopropylamine salt, glyphosate-trimesium salt, glyphosate-ammonium salt, glyphosate-diammonium salt, glyphosate-sodium salt, glyphosate-potassium salt, and glyphosate-guanidine salt.

Another embodiment of the present invention may be a herbicidal combination comprising saflufenacil, napropamide or napropamide-M and dicamba or a salt thereof selected from diglycolamine salt, dimethylammonium salt, isopropylammonium salt, potassium salt, sodium salt, and choline salt.

Another embodiment of the present invention may be a herbicidal combination comprising saflufenacil, napropamide or napropamide-M and 2,4-D or a salt or ester thereof selected from butotyl ester, dimethylammonium salt, diolamine salt, ethylhexyl ester, isooctyl ester, isopropylammonium salt, sodium salt, and triisopropanolamine salt.

Another embodiment of the present invention may be a herbicidal combination comprising saflufenacil, napropamide or napropamide-M and MCPA or a salt or ester thereof selected from dimethylammonium salt, 2-ethylhexylester, isooctyl ester, sodium salt, and choline salt.

Another embodiment of the present invention may be a herbicidal combination comprising saflufenacil, napropamide or napropamide-M and fluoroxypyr or fluoroxypyr-meptyl.

Another embodiment of the present invention may be a herbicidal combination comprising saflufenacil, napropamide or napropamide-M and picloram or a salt thereof selected from potassium salt, triisopanolammonium salt, and choline salt.

Another embodiment of the present invention may be a herbicidal combination comprising saflufenacil, napropamide or napropamide-M and quinclorac.

Another embodiment of the present invention may be a herbicidal combination comprising saflufenacil, napropamide or napropamide-M and quinmerac.

Another embodiment of the present invention may be a herbicidal combination comprising saflufenacil, napropamide or napropamide-M and glufosinate, glufosinate-ammonium salt, glufosinate-P or glufosinate-P-sodium salt.

Another embodiment of the present invention may be a herbicidal combination comprising saflufenacil, napropamide or napropamide-M and mesotrione.

Another embodiment of the present invention may be a herbicidal combination comprising saflufenacil, napropamide or napropamide-M and diflufenican.

Another embodiment of the present invention may be a herbicidal combination comprising saflufenacil, napropamide or napropamide-M and metolachlor or S-metolachlor.

Another embodiment of the present invention may be a herbicidal combination comprising saflufenacil, napropamide or napropamide-M and pretilachlor.

Another embodiment of the present invention may be a herbicidal combination comprising saflufenacil, napropamide or napropamide-M and flufenacet.

Another embodiment of the present invention may be a herbicidal combination comprising saflufenacil, napropamide or napropamide-M and bentazone.

Another embodiment of the present invention may be a herbicidal combination comprising saflufenacil, napropamide or napropamide-M and diuron.

Another embodiment of the present invention may be a herbicidal combination comprising saflufenacil, napropamide or napropamide-M and propanil.

Another embodiment of the present invention may be a herbicidal combination comprising saflufenacil, napropamide or napropamide-M and atrazine.

Another embodiment of the present invention may be a herbicidal combination comprising saflufenacil, napropamide or napropamide-M and metamitron.

Another embodiment of the present invention may be a herbicidal combination comprising saflufenacil, napropamide or napropamide-M and metribuzin.

Another embodiment of the present invention may be a herbicidal combination comprising saflufenacil, napropamide or napropamide-M and desmedipham.

Another embodiment of the present invention may be a herbicidal combination comprising saflufenacil, napropamide or napropamide-M and phenmedipham.

Another embodiment of the present invention may be a herbicidal combination comprising saflufenacil, napropamide or napropamide-M and oxyfluorfen.

Another embodiment of the present invention may be a herbicidal combination comprising saflufenacil, napropamide or napropamide-M and acifluorfen.

Another embodiment of the present invention may be a herbicidal combination comprising saflufenacil, napropamide or napropamide-M and fomesafen or fomesafen-sodium salt.

Another embodiment of the present invention may be a herbicidal combination comprising saflufenacil, napropamide or napropamide-M and pendimethalin.

Each of the combinations described above along with all the above described embodiments may be used in one or more aspects of the invention.

Each of the embodiments described hereinabove may apply to one or all of the aspects described hereinafter. These embodiments are intended to be read as being preferred features of one or all of the aspects described. Each of the embodiments described above applies to each of the aspects described individually.

In an embodiment, the present invention provides preferred combinations, compositions and methods thereof. The methods of the invention include a composition comprising the combination and a method of controlling weeds at a locus by application at the locus of the plant the combination or the composition. The embodiments described herein describe the preferred embodiments of all these possible combinations, compositions and methods of the invention.

In an embodiment, the total amount of saflufenacil in the composition may typically be in the range of 0.1 to 99% by weight, preferably 0.2 to 90% by weight. The total amount of napropamide or napropamide-M in the composition may be in the range of 0.1 to 99% by weight. The total amount of third herbicide in the composition may be in the range of 0.1 to 99% by weight.

In an embodiment, the constituent herbicides of the combination of the present invention may be admixed in ratio of (1-80):(1-80):(1-80) of saflufenacil, napropamide or napropamide-M and a third herbicide respectively.

In an aspect, the present invention may provide synergetic herbicidal combinations comprising saflufenacil, napropamide or napropamide-m, a third herbicide and a fourth herbicide, wherein the fourth herbicide has a different mode of action as compared to the third herbicide.

In an aspect, the present invention may provide herbicidal combinations comprising saflufenacil, napropamide or napropamide-m, a third herbicide and an herbicidal safener.

In an embodiment, the safener may be selected from benoxacor, BPCMS, cloquintocet, cyometrinil, cyprosulfamide, dichlormid, dicyclonon, dietholate, fenchlorazole, fenclorim, flurazole, fluxofenim, furilazole, isoxadifen, jiecaowan, Jiecaoxi, mefenpyr, mephenate, metcamifen, naphthalic anhydride, oxabetrinil and their salts and esters.

The herbicidal combination of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., vines, kaki fruit, olive, plum, banana, oil palm, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

Thus, in another aspect, the present invention provides a method of controlling weeds at a locus, the method comprising applying a combination comprising saflufenacil, napropamide or napropamide-M and a third herbicide to the locus.

Thus, embodiments of the present invention may provide a method of controlling weeds at a locus, said method comprising application of synergistic combination of saflufenacil, napropamide or napropamide-M, a third herbicide and optionally a fourth active ingredient.

In an embodiment, the fourth active ingredient may selected from herbicide, insecticide, fungicide, biological agent, plant growth activator, fertilizers and combinations thereof.

In an embodiment, the present invention may provide a method of controlling weeds at a locus, said method comprising applications of synergistic combinations comprising saflufenacil, napropamide or napropamide-M, a third herbicide and a fourth herbicide which has a mode of action which is different from the third herbicide.

The target weeds may be selected from Urticaceae weeds: Urtica urens Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa; Portulacaceae weeds: Portulaca oleracea; Caryophyllaceae weeds: Stellaria media, Cerastium holosteoides, Cerastium glomeratum, Spergula arvensis, Silene gallica Molluginaceae weeds: Mollugo verticillata; Chenopodiaceae weeds: Chenopodium album, Chenopodium ambrosioides, Kochia scoparia, Salsola kali, Atriplex spp.; Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella; Papaveraceae weeds: Papaver rhoeas, Argemone Mexicana; Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus; Capparaceae weeds: Cleome affinis; Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis; Oxalidaceae weeds: Oxalis corniculata, Oxalis strica, Oxalis oxyptera; Geraniaceae weeds: Geranium carolinense, Erodium cicutarium; Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis; Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum Sterculiaceae weeds: Waltheria indica; Violaceae weeds: Viola arvensis, Viola tricolor; Cucurbitaceae weeds: Sicyos angulatus, Echinocystis lobata, Momordica charantia; Lythraceae weeds: Lythrum salicaria; Apiaceae weeds: Hydrocotyle sibthorpioides; Sapindaceae weeds: Cardiospermum halicacabum; Primulaceae weeds: Anagallis arvensis; Asclepiadaceae weeds: Asclepias syriaca, Ampelamus albidus; Rubiaceae weeds: Galium aparine, Galium spurium var. echinospermon, Spermacoce latifolia, Richardia brasiliensis, Borreria alata; Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia; Boraginaceae weeds: Myosotis arvensis; Lamiaceae weeds: Lamium purpureum, Lamium amplexicaule, Leonotis nepetaefolia, Hyptis suaveolens, Hyptis lophanta, Leonurus sibiricus, Stachys arvensis; Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides; Scrophulariaceae weeds: Veronica hederaefolia, Veronica persica, Veronica arvensis; Plantaginaceae weeds: Plantago asiatica; Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis; Liliaceae weeds: Allium canadense, Allium vineale; Commelinaceae weeds: Commelina communis, Commelina bengharensis, Commelina erecta; Poaceae weeds: Echinochloa crusgalli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annus, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis; Cyperaceae weeds: Cyperus microiria, Cyperus iria, Cyperus odoratus, Cyperus rotundus, Cyperus esculentus, Kyllinga gracillima Equisetaceae weeds: Equisetum arvense, Equisetum palustre, and the like

In an embodiment, the individual components of the combination of the present invention may be applied to the locus either simultaneously or sequentially, such that saflufenacil, napropamide or napropamide-M and a third herbicide may be applied in a tank mix or as a pre-mixed composition.

In an embodiment, combination of the present invention may be applied either pre or post emergent. The advantage of the combination is surprisingly good residual effects, when applied in pre-emergent as well as quick knockdown when applied post emergent leading to quick control of weeds.

The method of control of the present invention may be carried out by spraying the suggested tank mixes, or the individual herbicides may be formulated as a kit-of-parts containing various components that may be mixed as instructed prior to spraying.

In an embodiment the components of the present invention may be packaged such that saflufenacil, napropamide or napropamide-M and a third herbicide may be packaged separately and then tank mixed before the spraying.

In another embodiment the components of the present invention may be packaged such that saflufenacil, napropamide or napropamide-M and a third herbicide may be packaged separately, whereas other additives are packaged separately, such that the two maybe tank mixed at the time of spraying.

In another embodiment the components of the present invention may be packaged as composition such that saflufenacil, napropamide or napropamide-M and a third herbicide are formulated into one composition and other additives are packaged separately, such that the two maybe tank mixed at the time of spraying.

Therefore, in another aspect, the present invention provides a composition comprising saflufenacil, napropamide or napropamide-M and a third herbicide and at least one agrochemically acceptable excipient.

In an embodiment, the composition of the present invention may contain agriculturally acceptable adjuvants, carriers, diluents, emulsifiers, fillers, anti-foaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixes.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

Thus, in another aspect, the present invention provides a method of controlling weeds at a locus, said method comprising applying a composition comprising saflufenacil, napropamide or napropamide-M and a third herbicide and at least one agrochemically acceptable excipient.

Surprisingly, it has been found by the present inventors that saflufenacil, napropamide or napropamide-M, and a third herbicide when applied individually, was ineffective in the control of weeds, but demonstrated excellent synergistic control on weeds when applied together. The combination controlled the weed both pre and post emergently. The combination of saflufenacil, napropamide or napropamide-M and a third herbicide synergistically controlled broadleaf weeds, sedges, and grasses a particular locus. The current invention therefore provides advantageous methods of controlling weeds both pre and post emergently. The present method also provides a broader spectrum of controlling weeds that helps in resistance management, thus preventing the weed from becoming resistant to either of the herbicides whist providing a broader spectrum of control at lower use rates.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### Examples

Trials were carried out for evaluating the herbicidal mixtures of the invention on different weeds. The percentage control was calculated from the observed percent weed coverage data after 20 DAA and 30DAA. The results were tabulated as hereunder:

| | | Rotboellia | Digitaria | Sorghum | Rotboellia | Digitaria | Sorghum |
|---|---|---|---|---|---|---|---|
| | | sp | sp | sp | sp | sp | sp |
| | | Observed | Observed | Observed | Observed | Observed | Observed |
| Dose | | efficacy | efficacy | efficacy | efficacy | efficacy | efficacy |
| Treatment | Dosage | 20 DAA | | | 30 DAA | | |
| Untreated | — | 0.00 | 0.00 | 0.00 | 0.00 | 0.00 | 0.00 |
| check | | | | | | | |
| Saflufenacil + | 42 g/ha + | 0 | 0 | 0.00 | 20.67 | 25 | 23.3 |
| Napropamide | 1200 g/ha | | | | | | |
| Saflufenacil + | 49 g/ha + | 70 | 77.7 | 74.3 | 91 | 93.3 | 91.7 |
| Napropamide + | 1200 g/ha + | | | | | | |
| metribuzin | 240 g/ha | | | | | | |
| Saflufenacil + | 49 g/ha + | 65.7 | 73 | 71.3 | 85 | 91 | 87.3 |
| Napropamide + | 1200 g/ha + | | | | | | |
| metribuzin | 192 g/ha | | | | | | |

### CONCLUSION

It was thus found that the efficacy of saflufenacil and Napropamide combination was very poor initially. The addition of a third herbicide e.g. metribuzin surprising restored the efficacy of an otherwise poor combination to acceptable levels. The addition of a third herbicide was found surprisingly beneficial to an otherwise ineffective combination.

1. An herbicidal combination comprising saflufenacil, Napropamide or Napropamide-M, and a third herbicide selected from the group consisting of:
(a) an ACCase inhibitor selected from the group consisting of clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alkoxydim, clethodim, sethoxydim, tepraloxydim, tralkoxydim, and pinoxaden or mixtures thereof;
(b) an ALS inhibitor selected from the group consisting of amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium salt, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thiencarbazone, thiencarbazone-methyl thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, ipfencarbazone, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt, pyrithiobac, pyrithiobac-sodium salt, pyriminobac, pyriminobac-methyl, bispyribac, bispyribac sodium salt, pyribenzoxim, pyrimisulfan, pyriftalid, and triafamone;
(c) an EPSP synthase inhibitors selected from the group consisting of glyphosate, glyphosate-isopropylamine salt, glyphosate-trimesium salt, glyphosate-ammonium salt, glyphosate-diammonium salt, glyphosate-sodium salt, glyphosate-potassium salt, and glyphosate-guanidine salt;
(d) a synthetic auxin selected from the group consisting of dicamba and a salt thereof (diglycolamine salt, dimethylammonium salt, isopropylammonium salt, potassium salt, sodium salt, and choline salt), 2,4-D and a salt or ester thereof (butotyl ester, dimethylammonium salt, diolamine salt, ethylhexyl ester, isooctyl ester, isopropylammonium salt, sodium salt, and triisopropanolamine salt), 2,4-DB and a salt or ester thereof (dimethylammonium salt, isooctyl ester, and choline salt), MCPA and a salt or ester thereof (dimethylammonium salt, 2-ethylhexylester, isooctyl ester, sodium salt, and choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, tololamine salt, and choline salt), mecoprop-P and a salt or ester thereof (dimethylammonium salt, 2-ethylhexyl ester, isobutyl salt, potassium salt, and choline salt), dichlorprop and a salt or ester thereof (butotyl ester, dimethylammonium salt, 2-ethylhexyl ester, isooctyl ester, methyl ester, potassium salt, sodium salt, and choline salt), dichlorprop-P, dichlorprop-P dimethylammonium, triclopyr and a salt or ester thereof (butotyl ester and triethylammonium salt), fluoroxypyr, fluoroxypyr-meptyl, picloram and a salt thereof (potassium salt, triisopanolammonium salt, and choline salt), quinclorac, quinmerac, aminopyralid and a salt thereof (potassium salt, triisopanolammonium salt, and choline salt), clopyralid and a salt thereof (olamine salt, potassium salt, triethylammonium salt, and choline salt), and clomeprop, florpyrauxifen and salts and esters thereof, and halauxifen and salts and esters;
(e) an auxin transport inhibitor selected from the group consisting of diflufenzopyr and naptalam;
(f) a glutamate synthase inhibitor herbicide selected from the group consisting of glufosinate, glufosinate-ammonium salt, glufosinate-P, glufosinate-P-sodium salt, and bialaphos;
(g) a HPPD inhibitors herbicide selected from the group consisting of benzobicyclon, bicyclopyrone, fenquinotrione, mesotrione, sulcotrione, tefuryltrione, tembotrione, isoxachlorotole, isoxaflutole, benzofenap, pyrasulfotole, pyrazolynate, pyrazoxyfen, tolpyralate, and topramezone;
(h) a lipid synthesis inhibitor herbicide selected from the group consisting of butylate, cycloate, eptc, eptam, thiobencarb, and triallate;
(i) a carotenoid biosynthesis inhibitor herbicide selected from the group consisting of diflufenican, picolinafen, beflubutamid, norflurazon, fluridone, fluorochloridone, and flurtamone;
(j) a long chain fatty acid inhibitor herbicide selected from the group consisting of propachlor, metazachlor, alachlor, acetochlor, metolachlor, S-metolachlor, butachlor, pretilachlor, thenylchlor, indanofan, cafenstrole, fentrazamide, dimethenamid, dimethenamid-P, mefenacet, pyroxasulfone, fenoxasulfone, naproanilide, napropamide, D-napropamide, pyroxasulfone, anilofos, and flufenacet;
(k) a photosystem inhibitor herbicide selected from the group consisting of Ioxynil, ioxynil octanoate, bentazone, pyridate, bromoxynil, bromoxynil octanoate, chlorotoluron, dimefuron, diuron, linuron, fluometuron, isoproturon, isouron, tebuthiuron, benzthiazuron, methabenzthiazuron, propanil, metobromuron, metoxuron, monolinuron, siduron, simazine, atrazine, propazine, cyanazine, ametryne, simetryn, dimethametryn, prometryn, terbumeton, terbuthylazine, terbutryn, trietazine, hexazinone, metamitron, metribuzin, amicarbazone, bromacil, lenacil, terbacil, chloridazon, desmedipham, and phenmedipham;
(l) a PPO inhibitor herbicide selected from the group consisting of azafenidin, oxadiazone, oxadiargyl, carfentrazone, carfentrazone-ethyl, cinidon, cinidon-ethyl, sulfentrazone, pyraclonil, pyraflufen, pyraflufen-ethyl, butafenacil, fluazolate, fluthiacet, fluthiacet-methyl, flufenpyr, flufenpyr-ethyl, flumiclorac, flumiclorac-pentyl, pentoxazone, oxyfluorfen, acifluorfen, aclonifen, chlomethoxynil, chloronitrofen, nitrofen, bifenox, fluoroglycofene, fluoroglycofene-ethyl, fomesafen, fomesafen-sodium salt, lactofen, trifludimoxazin, and tiafenacil;
(m) a microtubule inhibitor herbicide selected from the group consisting of trifluralin, pendimethalin, ethafluralin, benfluralin, prodiamine, indaziflam, triaziflam, butamifos, dithiopyr, and thiazopyr; and
(n) a herbicide selected from the group consisting of molinate, esprocarb, pyributicarb, prosulfocarb, orbencarb, dimepiperate, aminocyclopyrachlor, aminocyclopyrachlor-methyl, aminocyclopyrachlor-potassium, difenoxuron, methyl dymron, bromobutide, dymron, cumyluron, diflufenzopyr, etobenzanid, tridiphane, amitrole, fenchlorazole, maleic hydrazide, oxaziclomefone, benfuresate, ACN, dalapon, chlorthiamid, flupoxam, bensulide, paraquat, paraquat-dichloride, lancotrione and its salts and esters, diquat, and diquat-dibromide, cyclopyrimorate, and clacyfos.

2. The herbicidal combination of claim 1 wherein the third herbicide is selected from the group consisting of clodinafop, clodinafop-propargyl, haloxyfop, haloxyfop-methyl, haloxyfop-P, haloxyfop-P-methyl, bensulfuron, bensulfuron-methyl, pyrazosulfuron, pyrazosulfuron-ethyl, sulfosulfuron, trifloxysulfuron-sodium, trifloxysulfuron, metsulfuron, metsulfuron-methyl, penoxsulam, imazamox, imazamox-ammonium, imazapic, imazapic-ammonium, imazethapyr, imazethapyr-ammonium, chlorimuron, bispyribac, bispyribac sodium, glyphosate, glyphosate-isopropylamine salt, glyphosate-trimesium salt, glyphosate-ammonium salt, glyphosate-diammonium salt, glyphosate-sodium salt, glyphosate-potassium salt and glyphosate-guanidine salt, dicamba or a salt thereof, 2,4-D or a salt or ester thereof, MCPA or a salt or ester thereof, fluoroxypyr or fluoroxypyr-meptyl, picloram or a salt thereof, quinmerac, a glufosinate herbicide selected from glufosinate, glufosinate-ammonium salt, glufosinate-P and glufosinate-P-sodium salt, mesotrione, diflufenican, metazachlor, metolachlor or S-metolachlor; pretilachlor; napropamide or D-napropamide; flufenacet; bentazone; diuron; propanil; atrazine; metamitron; metribuzin; desmedipham; phenmedipham; oxyfluorfen; acifluorfen; fomesafen or fomesafen-sodium; pendimethalin; paraquat or paraquat-dichloride; and diquat or diquat-dibromide.

3. A method of controlling weeds at a locus, the method comprising applying the combination of claim 1.

4. The method as claimed in claim 3, wherein the third herbicide is selected from the group consisting of clodinafop, clodinafop-propargyl, haloxyfop, haloxyfop-methyl, haloxyfop-P, haloxyfop-P-methyl, bensulfuron, bensulfuron-methyl, pyrazosulfuron, pyrazosulfuron-ethyl, sulfosulfuron, trifloxysulfuron-sodium, trifloxysulfuron, metsulfuron, metsulfuron-methyl, penoxsulam, imazamox, imazamox-ammonium, imazapic, imazapic-ammonium, imazethapyr, imazethapyr-ammonium, chlorimuron bispyribac, bispyribac sodium, glyphosate, glyphosate-isopropylamine salt, glyphosate-trimesium salt, glyphosate-ammonium salt, glyphosate-diammonium salt, glyphosate-sodium salt, glyphosate-potassium salt and glyphosate-guanidine salt, dicamba or a salt thereof, 2,4-D or a salt or ester thereof, MCPA or a salt or ester thereof, fluoroxypyr or fluoroxypyr-meptyl, picloram or a salt thereof, quinmerac, a glufosinate herbicide selected from glufosinate, glufosinate-ammonium salt, glufosinate-P and glufosinate-P-sodium salt, mesotrione, diflufenican, metazachlor, metolachlor or S-metolachlor; pretilachlor; napropamide or D-napropamide; flufenacet; bentazone; diuron; propanil; atrazine; metamitron; metribuzin; desmedipham; phenmedipham; oxyfluorfen; acifluorfen; fomesafen or fomesafen-sodium; pendimethalin; paraquat or paraquat-dichloride; and diquat or diquat-dibromide.

5. A composition comprising saflufenacil, Napropamide or Napropamide M, a third herbicide, and at least one agrochemically acceptable excipient, wherein the third herbicide is selected from the group consisting of:
(a) an ACCase inhibitor selected from the group consisting of clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alkoxydim, clethodim, sethoxydim, tepraloxydim, tralkoxydim, and pinoxaden or mixtures thereof;
(b) an ALS inhibitor selected from the group consisting of amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium salt, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thiencarbazone, thiencarbazone-methyl thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, ipfencarbazone, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt, pyrithiobac, pyrithiobac-sodium salt, pyriminobac, pyriminobac-methyl, bispyribac, bispyribac sodium salt, pyribenzoxim, pyrimisulfan, pyriftalid, and triafamone;
(c) an EPSP synthase inhibitors selected from the group consisting of glyphosate, glyphosate-isopropylamine salt, glyphosate-trimesium salt, glyphosate-ammonium salt, glyphosate-diammonium salt, glyphosate-sodium salt, glyphosate-potassium salt, and glyphosate-guanidine salt;
(d) a synthetic auxin selected from the group consisting of dicamba and a salt thereof (diglycolamine salt, dimethylammonium salt, isopropylammonium salt, potassium salt, sodium salt, and choline salt), 2,4-D and a salt or ester thereof (butotyl ester, dimethylammonium salt, diolamine salt, ethylhexyl ester, isooctyl ester, isopropylammonium salt, sodium salt, and triisopropanolamine salt), 2,4-DB and a salt or ester thereof (dimethylammonium salt, isooctyl ester, and choline salt), MCPA and a salt or ester thereof (dimethylammonium salt, 2-ethylhexylester, isooctyl ester, sodium salt, and choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, tololamine salt, and choline salt), mecoprop-P and a salt or ester thereof (dimethylammonium salt, 2-ethylhexyl ester, isobutyl salt, potassium salt, and choline salt), dichlorprop and a salt or ester thereof (butotyl ester, dimethylammonium salt, 2-ethylhexyl ester, isooctyl ester, methyl ester, potassium salt, sodium salt, and choline salt), dichlorprop-P, dichlorprop-P dimethylammonium, triclopyr and a salt or ester thereof (butotyl ester and triethylammonium salt), fluoroxypyr, fluoroxypyr-meptyl, picloram and a salt thereof (potassium salt, triisopanolammonium salt, and choline salt), quinclorac, quinmerac, aminopyralid and a salt thereof (potassium salt, triisopanolammonium salt, and choline salt), clopyralid and a salt thereof (olamine salt, potassium salt, triethylammonium salt, and choline salt), and clomeprop, florpyrauxifen and salts and esters thereof, halauxifen and salts and esters;
(e) an auxin transport inhibitor selected from the group consisting of diflufenzopyr and naptalam;
(f) a glutamate synthase inhibitor herbicide selected from the group consisting of glufosinate, glufosinate-ammonium salt, glufosinate-P, glufosinate-P-sodium salt, and bialaphos;
(g) a HPPD inhibitors herbicide selected from the group consisting of benzobicyclon, bicyclopyrone, fenquinotrione, mesotrione, sulcotrione, tefuryltrione, tembotrione, isoxachlorotole, isoxaflutole, benzofenap, pyrasulfotole, pyrazolynate, pyrazoxyfen, tolpyralate, and topramezone;
(h) a lipid synthesis inhibitor herbicide selected from the group consisting of butylate, cycloate, eptc, eptam, thiobencarb, and triallate;
(i) a carotenoid biosynthesis inhibitor herbicide selected from the group consisting of diflufenican, picolinafen, beflubutamid, norflurazon, fluridone, fluorochloridone, and flurtamone;
(j) a long chain fatty acid inhibitor herbicide selected from the group consisting of propachlor, metazachlor, alachlor, acetochlor, metolachlor, S-metolachlor, butachlor, pretilachlor, thenylchlor, indanofan, cafenstrole, fentrazamide, dimethenamid, dimethenamid-P, mefenacet, pyroxasulfone, fenoxasulfone, naproanilide, napropamide, D-napropamide, pyroxasulfone, anilofos, and flufenacet;
(k) a photosystem inhibitor herbicide selected from the group consisting of Ioxynil, ioxynil octanoate, bentazone, pyridate, bromoxynil, bromoxynil octanoate, chlorotoluron, dimefuron, diuron, linuron, fluometuron, isoproturon, isouron, tebuthiuron, benzthiazuron, methabenzthiazuron, propanil, metobromuron, metoxuron, monolinuron, siduron, simazine, atrazine, propazine, cyanazine, ametryne, simetryn, dimethametryn, prometryn, terbumeton, terbuthylazine, terbutryn, trietazine, hexazinone, metamitron, metribuzin, amicarbazone, bromacil, lenacil, terbacil, chloridazon, desmedipham, and phenmedipham;
(l) a PPO inhibitor herbicide selected from the group consisting of azafenidin, oxadiazone, oxadiargyl, carfentrazone, carfentrazone-ethyl, cinidon, cinidon-ethyl, sulfentrazone, pyraclonil, pyraflufen, pyraflufen-ethyl, butafenacil, fluazolate, fluthiacet, fluthiacet-methyl, flufenpyr, flufenpyr-ethyl, flumiclorac, flumiclorac-pentyl, pentoxazone, oxyfluorfen, acifluorfen, aclonifen, chlomethoxynil, chloronitrofen, nitrofen, bifenox, fluoroglycofene, fluoroglycofene-ethyl, fomesafen, fomesafen-sodium salt, lactofen, trifludimoxazin, and tiafenacil;
(m) a microtubule inhibitor herbicide selected from the group consisting of trifluralin, pendimethalin, ethafluralin, benfluralin, prodiamine, indaziflam, triaziflam, butamifos, dithiopyr, and thiazopyr; and
(n) a herbicide selected from the group consisting of molinate, esprocarb, pyributicarb, prosulfocarb, orbencarb, dimepiperate, aminocyclopyrachlor, aminocyclopyrachlor-methyl, aminocyclopyrachlor-potassium, difenoxuron, methyl dymron, bromobutide, dymron, cumyluron, diflufenzopyr, etobenzanid, tridiphane, amitrole, fenchlorazole, maleic hydrazide, oxaziclomefone, benfuresate, ACN, dalapon, chlorthiamid, flupoxam, bensulide, paraquat, paraquat-dichloride, lancotrione and its salts and esters, diquat, and diquat-dibromide, cyclopyrimorate, and clacyfos.

6. The composition as claimed in claim 5, wherein the third herbicide is selected from the group consisting of clodinafop, clodinafop-propargyl, haloxyfop, haloxyfop-methyl, haloxyfop-P, haloxyfop-P-methyl, bensulfuron, bensulfuron-methyl, pyrazosulfuron, pyrazosulfuron-ethyl, sulfosulfuron, trifloxysulfuron-sodium, trifloxysulfuron, metsulfuron, metsulfuron-methyl, penoxsulam, imazamox, imazamox-ammonium, imazapic, imazapic-ammonium, imazethapyr, imazethapyr-ammonium, chlorimuron, bispyribac, bispyribac sodium, glyphosate, glyphosate-isopropylamine salt, glyphosate-trimesium salt, glyphosate-ammonium salt, glyphosate-diammonium salt, glyphosate-sodium salt, glyphosate-potassium salt and glyphosate-guanidine salt, dicamba or a salt thereof, 2,4-D or a salt or ester thereof, MCPA or a salt or ester thereof, fluoroxypyr or fluoroxypyr-meptyl, picloram or a salt thereof, quinmerac, a glufosinate herbicide selected from glufosinate, glufosinate-ammonium salt, glufosinate-P and glufosinate-P-sodium salt, mesotrione, diflufenican, metazachlor, metolachlor or S-metolachlor; pretilachlor; napropamide or D-napropamide; flufenacet; bentazone; diuron; propanil; atrazine; metamitron; metribuzin; desmedipham; phenmedipham; oxyfluorfen; acifluorfen; fomesafen or fomesafen-sodium; pendimethalin; paraquat or paraquat-dichloride; and diquat or diquat-dibromide.

7. A method of controlling weeds at a locus, said method comprising applying the composition according to claim 5 to the locus.

8. The method as claimed in claim 7, wherein the third herbicide is selected from the group consisting of clodinafop, clodinafop-propargyl, haloxyfop, haloxyfop-methyl, haloxyfop-P, haloxyfop-P-methyl, bensulfuron, bensulfuron-methyl, pyrazosulfuron, pyrazosulfuron-ethyl, sulfosulfuron, trifloxysulfuron-sodium, trifloxysulfuron, metsulfuron, metsulfuron-methyl, penoxsulam, imazamox, imazamox-ammonium, imazapic, imazapic-ammonium, imazethapyr, imazethapyr-ammonium, bispyribac, bispyribac sodium, glyphosate, glyphosate-isopropylamine salt, glyphosate-trimesium salt, glyphosate-ammonium salt, glyphosate-diammonium salt, glyphosate-sodium salt, glyphosate-potassium salt and glyphosate-guanidine salt, dicamba or a salt thereof, 2,4-D or a salt or ester thereof, MCPA or a salt or ester thereof, fluoroxypyr or fluoroxypyr-meptyl, picloram or a salt thereof, quinmerac, a glufosinate herbicide selected from glufosinate, glufosinate-ammonium salt, glufosinate-P and glufosinate-P-sodium salt, mesotrione, diflufenican, metazachlor, metolachlor or S-metolachlor; pretilachlor; napropamide or D-napropamide; flufenacet; bentazone; diuron; propanil; atrazine; metamitron; metribuzin; desmedipham; phenmedipham; oxyfluorfen; acifluorfen; fomesafen or fomesafen-sodium; pendimethalin; paraquat or paraquat-dichloride; and diquat or diquat-dibromide.
